(19) United States
(12) Patent Application Publication
(10) Pub. No.: US 2026/0122203 A1
(43) Pub. Date: Apr. 30, 2026

(54) CONTROLLING CONFERENCE ROOM VIRTUAL MEETING DEVICES FROM A VIRTUAL MEETING USER INTERFACE

(71) Applicant: Google LLC, Mountain View, CA (US)

(72) Inventors: Michael Conradt, Munich (DE); Daniel Enrique Ferrara, New York, NY (US); Quentin Esterhuizen, Carle Pace, NY (US); Simon Paul Smith, Brighton (GB); Ingo Wehmeyer, Munich (DE); Radu Marginean, Munich (DE)

(21) Appl. No.: 18/929,494

(22) Filed: Oct. 28, 2024

(51) Int. Cl. H04N 7/15

(52) U.S. Cl. CPC H04N 7/157; H04N 7/152

(57) ABSTRACT

A method includes presenting, at a first client device, a virtual meeting UI. The method includes obtaining meeting device data from a controller device in a conference room. The controller device manages one or more meeting devices in the conference room. The meeting device data includes an indication of a first meeting device one or more features of the first meeting device. The method includes causing the virtual meeting UI to display the indication of the first meeting device and the one or more features of the first meeting device. The method includes receiving, via the virtual meeting UI, user input selecting a first feature of the first meeting device. The method includes providing, to the controller device, meeting device control data indicating the first meeting device and the first feature to cause the first meeting device to perform the first feature during the virtual meeting.

### TECHNICAL FIELD

Aspects and implementations of the present disclosure relate to virtual meetings and more specifically to controlling conference room virtual meeting devices from a virtual meeting user interface.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video streams (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for controlling conference room virtual meeting devices from a virtual meeting user interface (UI). The method includes presenting, at a first client device of one or more client devices, a virtual meeting UI during a virtual meeting between one or more participants associated with the one or more client devices. A subset of the one or more participants are located in a conference room. The method includes obtaining, at the first client device, meeting device data from a controller device in the conference room. The controller device manages one or more meeting devices in the conference room. The meeting device data may include an indication of a first meeting device of the one or more meeting devices. The meeting device data may include an indication of one or more features of the first meeting device. The method includes causing the virtual meeting UI to display the indication of the first meeting device and the one or more features of the first meeting device. The method includes receiving, via the virtual meeting UI, user input selecting a first feature of the one or more features of the first meeting device. The method includes providing, to the controller device, meeting device control data indicating the first meeting device and the first feature to cause the first meeting device to perform the first feature during the virtual meeting.

Another aspect of the disclosure provides a system for controlling conference room virtual meeting devices from a virtual meeting user interface. The system includes a memory and processing device coupled with the memory. The processing device is configured to perform operations. The operations include presenting, at a first client device of one or more client devices, a virtual meeting UI during a virtual meeting between one or more participants associated with the one or more client devices. A subset of the one or more participants are located in a conference room. The operations include obtaining, at the first client device, meeting device data from a controller device in the conference room. The controller device manages one or more meeting devices in the conference room. The meeting device data may include an indication of a first meeting device of the one or more meeting devices. The meeting device data may include an indication of one or more features of the first meeting device. The operations include causing the virtual meeting UI to display the indication of the first meeting device and the one or more features of the first meeting device. The operations include receiving, via the virtual meeting UI, user input selecting a first feature of the one or more features of the first meeting device. The operations include providing, to the controller device, meeting device control data indicating the first meeting device and the first feature to cause the first meeting device to perform the first feature during the virtual meeting.

Another aspect of the disclosure provides a non-transitory computer-readable storage medium with instructions that, when executed by a processing device, causes the processing device to perform operations. The operations include presenting, at a first client device of one or more client devices, a virtual meeting UI during a virtual meeting between one or more participants associated with the one or more client devices. A subset of the one or more participants are located in a conference room. The operations include obtaining, at the first client device, meeting device data from a controller device in the conference room. The controller device manages one or more meeting devices in the conference room. The meeting device data may include an indication of a first meeting device of the one or more meeting devices. The meeting device data may include an indication of one or more features of the first meeting device. The operations include causing the virtual meeting UI to display the indication of the first meeting device and the one or more features of the first meeting device. The operations include receiving, via the virtual meeting UI, user input selecting a first feature of the one or more features of the first meeting device. The operations include providing, to the controller device, meeting device control data indicating the first meeting device and the first feature to cause the first meeting device to perform the first feature during the virtual meeting.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for controlling conference room virtual meeting devices from a virtual meeting user interface (UI), in accordance with some implementations of the present disclosure.

FIG. 2 depicts a flow diagram of a method for controlling conference room virtual meeting devices from a virtual meeting UI, in accordance with some implementations of the present disclosure.

FIG. 3 depicts an example system architecture for controlling conference room virtual meeting devices from a virtual meeting UI, in accordance with some implementations of the present disclosure.

FIG. 4 depicts an example virtual meeting UI, in accordance with some implementations of the present disclosure.

FIG. 5 depicts an example virtual meeting UI, in accordance with some implementations of the present disclosure.

FIG. 6 depicts a flow diagram of a method for controlling conference room virtual meeting devices from a virtual meeting UI, in accordance with some implementations of the present disclosure.

FIG. 7 depicts an example virtual meeting UI, in accordance with some implementations of the present disclosure.

FIG. 8 is a block diagram illustrating an example computer system, in accordance with some implementations of the present disclosure.

### DETAILED DESCRIPTION

Aspects of the present disclosure relate to controlling conference room virtual meeting devices from a virtual meeting user interface (UI). A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a UI to each client device connected to the virtual meeting, where the UI displays visual items corresponding to the video streams shared over the network in a set of regions in the UI.

In some virtual meetings, some participants can be located in a conference room. The conference room can have multiple meeting devices used during the virtual meeting. For example, the meeting devices can include multiple cameras (e.g., a first camera facing a podium or stage of the conference room and a second camera facing an audience area of the conference room) and multiple microphones (e.g., a podium microphone and a wireless audience microphone). In a typical conference room setup, the multiple meeting devices are connected to a controller device. The controller device can have a UI that can be used to control certain aspects of the multiple meeting devices. The controller device can be connected to a computing device running virtual meeting software and can provide an audio and video feed to the computing device. The computing device running the virtual meeting software can then use the received feeds to broadcast the video and audio feed to virtual meeting participants that are not located in the conference room. In other words, to the computing device, the controller device can appear to be a typical video camera and microphone.

This typical conference room arrangement presents several disadvantages. First, the computing device that receives the video and audio feeds from the controller device cannot control the meeting devices; it can only start or stop receiving the video and audio feeds from the controller device. Thus, in order to control the meeting devices, a user should use a UI of the controller device, requiring the user to be in the conference room. Second, the computing device cannot determine what specific meeting devices are in use in the conference room. As stated above, the computing device running the virtual meeting software only receives an audio and video feed from the computing device. Because of this, the computing device cannot determine if the meeting devices are working or if any of them have experienced an error.

Implementations of the present disclosure address the above and other deficiencies by obtaining meeting device data from a controller device in a conference room. The controller device implements a technical specification to provide the meeting device data to virtual meeting software. The meeting device data can include data indicating one or more meeting devices connected to the controller device, statuses of the meeting devices, and/or features of the meeting devices (e.g., operations the meeting devices can perform). The virtual meting software can then cause the virtual meeting UI to enumerate the one or more meeting devices and their respective statuses and features based on the meeting device data. A user (e.g., a remote virtual meeting participant, a virtual meeting participant in the conference room, a system administrator, etc.) can provide input to the virtual meeting UI to control a feature of a meeting device.

Aspects of the present disclosure provide technical advantages over previous solutions. One technical problem includes the inability of a computing device that is running virtual meeting software to enumerate meeting devices in a conference room that are being used during a virtual meeting. Aspects of the present disclosure can provide meeting device data from a controller device to the virtual meeting software in order to enumerate such devices. Another technical problem includes the inability of the computing device running the virtual meeting software to control operations of the meeting devices. Aspects of the present disclosure can provide commands from the virtual meeting software to a controller device connected to the meeting devices to cause the meeting devices to perform the desired operations. Thus, aspects of the present disclosure enhance the abilities of virtual meeting software and enhance participants' experience during a virtual meeting.

It should be noted that although aspects of the present disclosure are described with reference to a conference room, they should not be so limited, and can be used in any other space or location having a controller device that is able to communicate with meeting devices and a computing device providing some virtual meeting functionality.

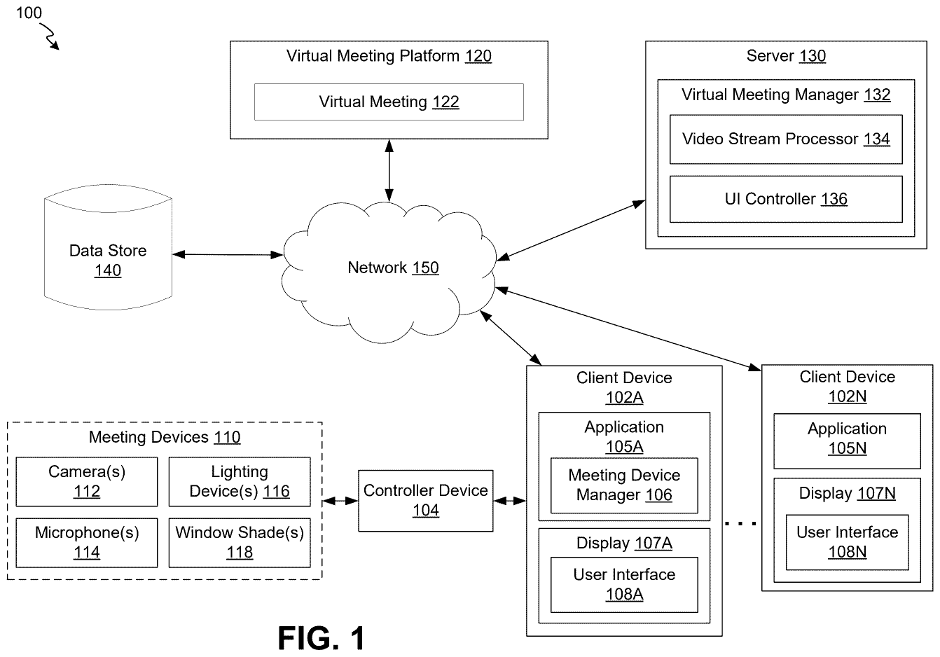

FIG. 1 illustrates an example system architecture 100, in accordance with implementations of the present disclosure. The system architecture 100 includes one or more client devices 102A-N, a virtual meeting platform 120, a server 130, and a data store 140, each connected to a network 150.

In some implementations, the virtual meeting platform 120 enables users of one or more of the client devices 102A-N to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102A-N to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-N by the client applications 105A-N executing on the operating systems of the client devices 102A-N. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102A-N. The video stream processor 134 may be configured to determine visual items for presentation in the UI of such client devices 102A-N (e.g., the UIs 108-108N, discussed below) during the virtual meeting 122. Each visual item can correspond to a video stream from a client device 102A-N (e.g., the video stream pertaining to one or more participants of the virtual meeting 122). In some implementations, the video stream processor 134 receives audio streams associated with the video streams from the client devices (e.g., from an audiovisual component of the client devices 102A-N). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can display a video stream pertaining to one or more participants of the virtual meeting 122. The UI controller 136 can control which video stream is to be displayed by providing a command to one or more client devices 102A-N that indicates which video stream is to be displayed in which region of the UI (along with the received video and audio streams being provided to the client devices 102A-N). For example, in response to being notified of the determined visual items for presentation in the UI 108A-N, the UI controller 136 can transmit a command causing each determined visual item to be displayed in a region of the UI and/or rearranged in the UI.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, a first client device 102A is associated with a physical conference or meeting room. Such client device 102A can include or be coupled to a controller device 104. The controller device 104 may include a device configured to control one or more meeting devices 110 connected to the controller device 104 and to provide data (e.g., an audio or video stream generated by some of the meeting devices 110) to the first client device 102A.

In one implementation, the controller device 104 includes a device configured to process and route audio and/or video, control the meeting devices 110, or perform other meeting device-control operations. The controller device 104 may include one or more audio channels, analog channels, video ports (e.g., High-Definition Multimedia Interface (HDMI) ports or other video interface ports), data exchange ports (e.g., Universal Serial Bus (USB) ports or other data exchange ports), ethernet or other network connectivity ports, etc.

In some implementations, the meeting devices 110 includes devices configured to perform operations during a meeting in the physical conference or meeting room that help carry out a meeting (which may include the virtual meeting 122). Each meeting device 110 may be configured to perform one or more features. A feature of a meeting device 110 may include an operation or function of the meeting device 110.

In one implementation, the meeting devices 110 include one or more cameras 112. A camera 112 may include a video camera. A camera 112 may include a camera physically connected to the controller device 104 (e.g., via a USB cable or a video cable) or can be connected to the controller device 104 over a network (e.g., an Internet Protocol (IP) camera). Features of a camera 112 may include muting the camera 112 (e.g., causing the camera 112 to not provide its video stream to the controller device 104), unmuting the camera 112 (e.g., causing the camera 112 to provide its video stream to the controller device 104), or performing a pan/tilt/zoom (PTZ) operation.

The one or more cameras 112 may include multiple cameras located in different locations in the conference or meeting room. For example, the one or more cameras 112 may include a first camera facing a podium, stage, or other speaking area of the conference or meeting room, and a second camera facing an audience area of the conference or meeting room.

In some implementations, the meeting devices 110 include one or more microphones 114. A microphone 114 may include a wired microphone or a wireless microphone. Features of a microphone 114 may include muting the microphone 114, unmuting the microphone 114, increasing or decreasing the volume of the microphone 114, or other operations that the microphone can perform.

In one implementation, the meeting devices 110 include one or more lighting devices 116. A lighting device 116 may include a lighting fixture, lamp, or other device that provides illumination to the conference or meeting room. A lighting device 116 may include a lighting system that controls one or more lighting devices. Features of a lighting device 116 may include activating the lighting device 116, deactivating the lighting device 116, increasing a brightness of the lighting device 116, decreasing the brightness of the lighting device 116, changing a lens associated with the lighting device (e.g., to cause the lighting device to display different colors), modifying a color of the lighting device (e.g., by changing the intensity of one or more color chips of a the lighting device), modifying a color temperature of the lighting device, or other lighting device operations. The one or more lighting devices 116 may include multiple lighting devices located in different locations in the conference or meeting room. For example, a first lighting device 116 may include a lighting system that controls one or more lights that illuminate a stage area, and a second lighting device 116 may include a lighting system that controls one or more lights that illuminate an audience area.

In some implementations, the meeting devices 110 include one or more window shade devices 118. A window shade device 118 may control movement of a window shade (a piece of material that can cover a window in order to prevent external light (e.g., sunlight) from entering the conference or meeting room). The window shade device 118 may include a mechanical device (e.g., a roller) that can extend the widow shade (e.g., move the window shade into a light-blocking position) or retract the window shade (e.g., move the window shade to allow sunlight into the conference or meeting room). Features of the window shade device 118 may include extending or retracting the window shade 118.

In one implementation, the meeting devices 110 includes one or more room divider devices. A room divider device may include a partition wall or some other device that divides a physical space (e.g., the conference or meeting room) into multiple portions. A partition wall may include a partition that can fold; rotate; extend or retract from a wall, floor, or ceiling; or perform some other movement action to divide a physical space. The room divider device may include one or more mechanical devices that moves a portion of the partition wall (e.g., a motor for rotating a portion of the partition wall, a geared track for extending or retracting a portion of the partition wall, etc.). Features of the room divider device may include closing the partition wall (e.g., so that the physical space is divided into multiple portions) or opening the partition wall (e.g., so that the physical space is not divided into multiple portions).

In some implementations, the meeting devices 110 include other types of devices such as one or more display devices, one or more speakers, or other devices. A display device can be, for example, a smart display or a non-smart display (e.g., a display that is not itself configured to connect to the network 150). Users that are physically present in the conference or meeting room can use a display device to show a slide presentation or a video or to watch slide presentations or videos of other virtual meeting 122 participants.

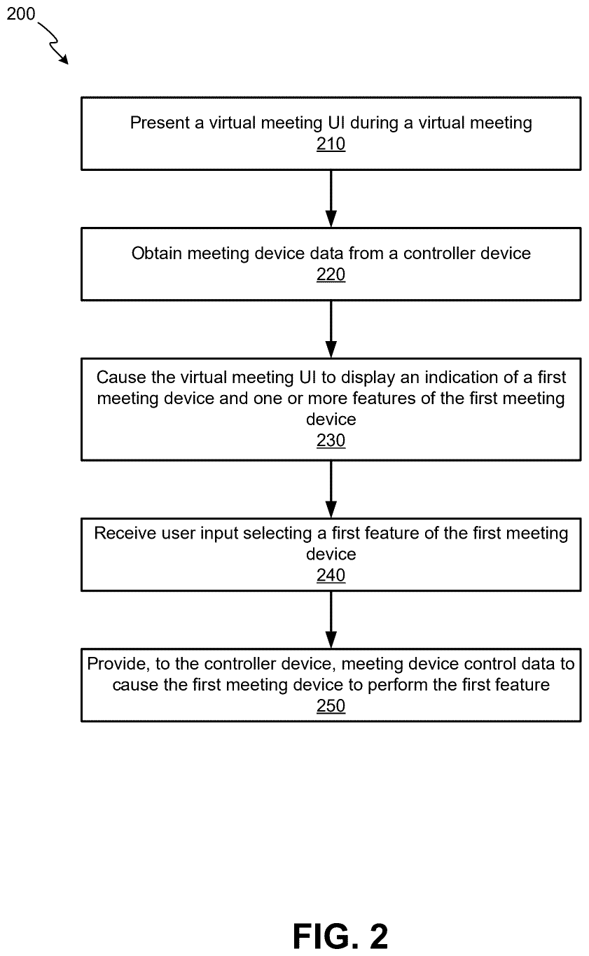

In one or more implementations, a client device 102A includes a meeting device manager 106. The meeting device manager 106 may include a software application (or a subset thereof, e.g., a subset of the client application 105A) that is configured to obtain meeting device data about the meeting devices 110 from the controller device 104. The meeting device manager 106 may cause the virtual meeting UI 108A of the client device 102A to display indications of the meeting devices 110, their respective statuses, and/or their respective features. The meeting device manager 106 can be configured to obtain user input (e.g., from the virtual meeting UI 108A) that selects a feature of a meeting device of the meeting devices 110 and can cause the controller device 104 to receive meeting device control data that causes a meeting device to perform a feature as indicated by the user input. Functionality of the meeting device manager 106 is discussed further below in relation to FIG. 2.

As described previously, an audiovisual component of each client device 102A-N can capture images and generate video data (e.g., a video stream) of the captured data of the captured images. In some implementations, the client devices 102A-N transmit the generated video stream to virtual meeting manager 132. The audiovisual component of each client device 102A-N can also capture an audio signal representing speech of a user and generate audio data (e.g., an audio file or audio stream) based on the captured audio signal. In some implementations, the client devices 102A-N transmit the generated audio data to the virtual meeting manager 132.

In some implementations, each client device 102A-N includes a respective client application 105A-N, which can be a mobile application, a desktop application, a web browser, etc. The client application 105A-N can present, on a display device 107A-N of a client device 102A-N or a UI (e.g., a UI of the UIs 108A-N), one or more features of the application 105A-N for users to access the virtual meeting platform 120. For example, a user of client device 102A can join and participate in the virtual meeting 122 via a virtual meeting UI 108A presented on the display device 107A by the client application 105A. The user can present a document to participants of the virtual meeting 122 using the virtual meeting UI 108A. Each of the UIs 108A-N can include multiple regions to present visual items corresponding to video streams of the client devices 102A-N provided to the server 130 for the virtual meeting 122.

In one or more implementations, the meeting device manager 106 is part of a client device 102A-N. For example, as shown in FIG. 1, the client application 105A can include the meeting device manager 106. In other implementations, the virtual meeting manager 132 includes the meeting device manager 106. For example, the controller device 104 can provide meeting device data to the client application 105A, and the client application 105A can provide the meeting device data to the meeting device manager 106 on the server 130. The meeting device manager 106 can process the meeting device data and can provide data to the client application 105A that causes the virtual meeting UI 108A to display data regarding the meeting devices 110. Responsive to user input to the virtual meeting UI 108A, the client application 105A can provide data to the meeting device manager 106 on the server 130, and the meeting device manager 106 can provide meeting device control data to the client application 105A to provide to the controller device 104 to control one or more of the meeting devices 110. In some implementations, the client application 105A sends the video stream to the other client devices 102B-N and receives the video streams from the other client devices 102B-N. The applications 105A-105N can generate their respective virtual meeting UIs 108A-N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for controlling conference room virtual meeting devices from a virtual meeting UI, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the meeting device manager 106 performs one or more of the operations of the method 200.

At block 210, processing logic presents, at a first client device 102A of one or more client devices 102A-N, a virtual meeting UI 108A during a virtual meeting 122 between one or more participants associated with the one or more client devices 102A-N. A subset of the one or more participants can be located in a conference room.

At block 220, processing logic obtains, at the first client device 102A, meeting device data from a controller device 104 in the conference room. In some implementations, the meeting device data is obtained before the first client device 102A joins the virtual meeting 122. Alternatively, the meeting device data is obtained continuously during the virtual meeting 122. Yet alternatively, the meeting device data is obtained upon a request of a user submitted via a UI. The user can be a virtual meeting participant (e.g. located in the conference room or remotely) or another user who has appropriate privileges (e.g., a system administrator). The meeting device manager 106 can obtain the meeting device data. The controller device 104 can manage one or more meeting devices 110 in the conference room. The meeting device data may include an indication of a first meeting device of the one or more meeting devices 110. The meeting device data may include an indication of one or more features of the first meeting device.

The data indicating the first meeting device may include data that enumerates, identifies, or describes the first meeting device. The data indicating the first meeting device may include a name of the first meeting device, a type of the first meeting device (e.g., camera, microphone, etc.), an identifier (e.g., a medium access control (MAC) address, etc.), or other data. The data indicating one or more features of the first meeting device may include data that indicates a name of the feature (e.g., for a camera, “mute video feed,” “unmute video feed,” “pan,” “zoom-in,” etc.).

In some implementations, the meeting device data includes a status of the first meeting device. A status of the first meeting device may include data indicating an operating condition of the meeting device. A status of the first meeting device may include a “normal” status. A normal status can indicate that the first meeting device is on and is functioning as intended. A status of the first meeting device may include an “offline” status. An offline status may include the first meeting device being off, in a low-power state, or a state where the first meeting device may need to perform one or more preparatory operations in order to change to a normal status. A status of the first meeting device may include the first meeting device having an error (e.g., being in an error state). Being in an error state may include the first meeting device not operating normally and may need intervention (e.g., a restart or repair) in order to change to a normal status.

In one implementation, the first meeting device of the one or more meeting devices 110 includes a system of multiple cameras 112. The indication of the one or more features of the system of multiple cameras 112 may include changing an active camera from a first camera 112 of the multiple cameras 112 to a second camera 112. In some implementations, the multiple cameras 112 each provide a video stream to the controller device 104, and the controller device 104 can provide one of the video streams to the first client device 102A. Changing the active camera 112 may include the controller device 104 changing which video stream the controller device 104 provides to the first client device 102A. In one implementation, changing the active camera 112 includes the controller device 104 muting a first camera 112 (which may stop the first camera 112 from providing its video stream to the controller device 104) and unmuting a second camera 112 (which can cause the second camera 112 to provide its video stream to the controller device 104) and providing the video stream from the unmuted second camera 112 to the first client device 102A.

In some implementations, the first meeting device of the one or more meeting devices 110 includes a system of multiple microphones 114. The indication of the one or more features of the system of multiple cameras 112 may include changing an active microphone 114 from a first microphone 114 of the multiple microphones 114 to a second microphone 114. In one or more implementations, the multiple microphones 114 each provide an audio stream to the controller device 104, and the controller device 104 can provide one of the audio streams to the first client device 102A. Changing the active microphone 114 may include the controller device 104 changing which audio stream the controller device 104 provides to the first client device 102A. In one implementation, changing the active microphone 114 includes the controller device 104 muting a first microphone 114 (which may stop the first microphone 114 from providing its audio stream to the controller device 104) and unmuting a second microphone 114 (which can cause the second microphone 114 to provide its audio stream to the controller device 104) and providing the audio stream from the unmuted second microphone 114 to the first client device 102A.

In some implementations, the controller device 104 implements a technical specification provided by the developer of the virtual meeting software executing on the first client device 102A (e.g., the client application 105A). The technical specification can indicate how to send meeting device data to the client device 102A and a data format for the meeting device data the controller device 104 sends to the first client device 102A in block 220. The technical specification can indicate how to obtain meeting device control data from the first client device 102A, as discussed below. The controller device 104 can implement the technical specification by being configured to interact with an application programming interface (API) or another type of interface between the controller device 104 and the first client device 102A.

At block 230, processing logic causes the virtual meeting UI 108A to display the indication of the first meeting device (e.g., by updating the virtual meeting UI 108A to display the indication of the first meeting device or by sending the meeting device data to the server 130 which can then update the virtual meeting UI 108A to display the indication of the first meeting device and provide it for presentation on the first client device 102A). Processing logic can cause the virtual meeting UI 108A to display the indication of the one or more features of the first meeting device. The meeting device manager 106 can cause the virtual meeting UI 108A to display the indications. In some implementations, the virtual meeting UI 108A displaying the indication of the first meeting device is presented to each participant of the virtual meeting 122. Alternatively, the virtual meeting UI 108A displaying the indication of the first meeting device is presented to participants located in the conference room and not to the remote participants of the virtual meeting 122. Yet alternatively, the virtual meeting UI 108A displaying the indication of the first meeting device is presented to a user (e.g., a system administrator) having particular privileges (e.g., upon such a user entering their credentials) but not to any participants of the virtual meeting 122 who do not have the required privileges.

In one implementation, the virtual meeting UI 108A displaying the indication of the first meeting device includes the virtual meeting UI 108A displaying a UI element that corresponds to the first meeting device. The UI element may include a box or other enclosed UI element. The UI element can display data indicating the first meeting device, which may include a name of the first meeting device, a type of the first meeting device, or other data. In some implementations, the virtual meeting UI 108A displays the status of the first meeting device. For example, the UI element corresponding to the first meeting device can display text that indicates the status, a color (e.g., green for normal, gray for offline, red for error, or the like).

In one or more implementations, the virtual meeting UI 108A displaying the indication of the one or more features of the first meeting device includes displaying one or more UI elements that each correspond to a feature of the one or more features. The UI elements may include UI elements that a user of the first client device 102A can interact with (e.g., buttons, sliders, or the like).

In some implementations, the meeting device data includes an indication of multiple meeting devices 110, including the first meeting device discussed above. The virtual meeting UI 108A displaying the indication of the first meeting device may include the virtual meeting UI 108A displaying indications of the multiple meeting devices 110. Displaying indications of multiple meeting devices 110 may include displaying a tree structure that organizes the multiple meeting devices into one or more groups of meeting devices 110.

In one implementation, the one or more groups of the tree structure are based on meeting device type. For example, each child node of the root node may include a meeting device type, and for each meeting device type node, its respective children nodes may include the meeting devices 110 that belong to the respective meeting device type.

In some implementations, the one or more groups of the tree structure are based on one or more locations of the multiple meeting devices 110. In some cases, meeting devices 110 can be located in different conference or meeting rooms. The meeting devices 110 can be connected to respective controller device 104, each of which can be in data communication with the first client device 102A. The tree structure may include each child node of the root node corresponding to a different conference or meeting room, and the one or more children nodes of the conference or meeting room nodes may include the one or more meeting devices 110 located in the respective meeting room.

At block 240, processing logic receives, via the virtual meeting UI 108A, user input. The user input can select a first feature of the one or more features of the first meeting device. For example, as discussed above, the virtual meeting UI 108A may include a button UI element that indicates a feature of the first meeting device. A user of the first client device 102A can interact with the button UI element to select the first feature. The meeting device manager 106 can obtain data from the virtual meeting UI 108A indicating the selected first feature of the first meeting device.

At block 250, processing logic provides, to the controller device 104, meeting device control data. The meeting device control data can indicate the first meeting device and the first feature. The meeting device control data can cause the first meeting device to perform the first feature during the virtual meeting 122.

In one implementation, the meeting device manager 106 generates the meeting device control data based on the data from the virtual meeting UI 108A indicating the selected first feature of the first meeting device. The meeting device manager 106 can provide the meeting device control data to the controller device 104. The controller device can provide a command to the first meeting device, and the command, when received by the first meeting device, can cause the first meeting device to perform the first feature.

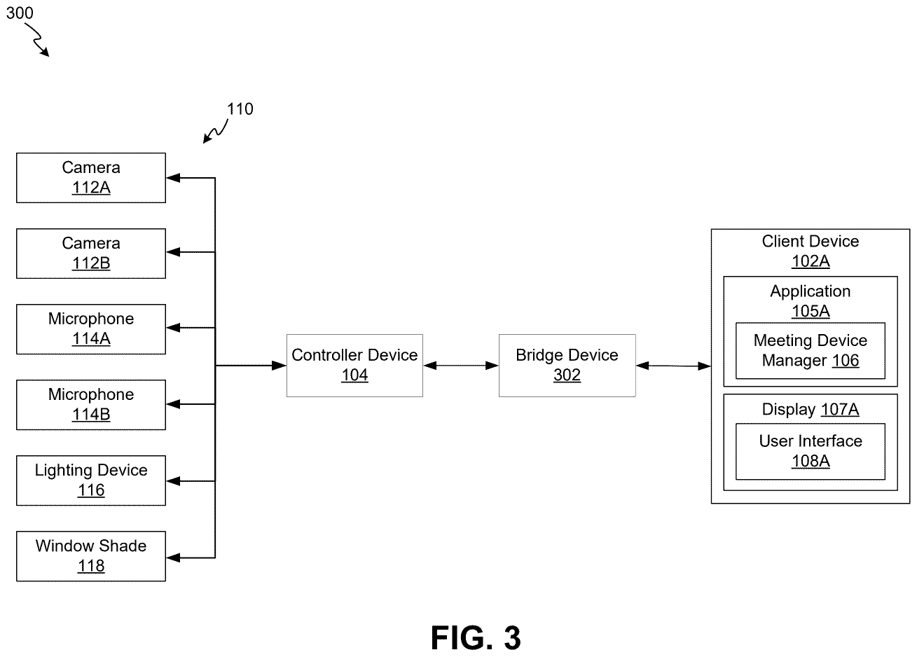

FIG. 3 depicts an example system architecture 300 for controlling conference room virtual meeting devices 110 from a virtual meeting UI 108A, in accordance with some implementations of the present disclosure. The system 300 may include one or more components of the system 100 of FIG. 1, including the first client device 102A (with its respective client application 105A, meeting device manager 106, display device 107A, and virtual meeting UI 108A), the controller device 104, and one or more meeting devices 110, such as a first camera 112A, a second camera 112B, a first microphone 114A, a second microphone 114B, a lighting device 116, and a window shade 118.

As can be seen in FIG. 3, the meeting devices 110 may each be connected to the controller device 104. Some meeting devices 110 can provide data to the controller device 104 (e.g., a camera 112A-B can provide a video stream, or a microphone 114A-B can provide an audio stream). The controller device 104 can provide a command or signal to a meeting device to cause the meeting device to perform a feature (e.g., the controller device 104 can provide a signal to the window shade 118 to cause the window shade to extend to block sunlight from entering the conference or meeting room through a window).

In some implementations, the controller device 104 is connected to a bridge device 302, which can be connected to the first client device 102A. The bridge device 302 may include a device configured to obtain data from the controller device 104 and convert the data into a format compatible with the first client device 102A. In some cases, the controller device 104 may not provide output in a format compatible with the first client device 102A. For example, the first client device 102A may include a USB port that can be used to receive video and audio data, but the controller device 104 may not be configured to provide data over a USB cable. The bridge device 302 may include an interface compatible with an output of the controller device 104 and an interface compatible with the first client device 102A. The bridge device 302 may include software and data that aids in converting the data (e.g., codecs, emulators, etc.). In some implementations, the controller device 104 may include the bridge device 302 or can perform operations of the bridge device 302 such that a separate bridge device 302 may not be needed.

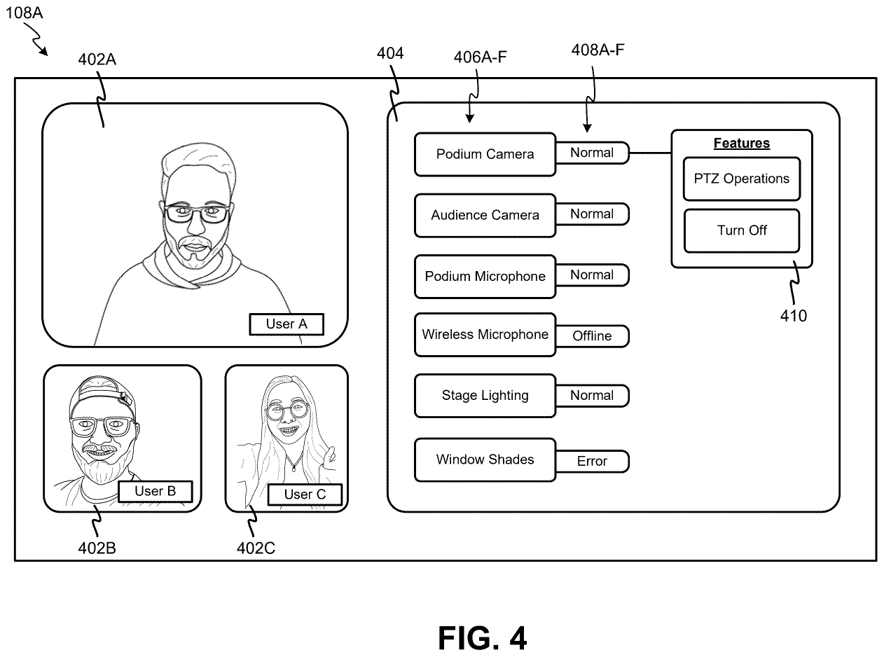

FIG. 4 depicts an example virtual meeting UI 108A, in accordance with some implementations of the present disclosure. The virtual meeting UI 108A may include one or more first regions 402A-C. A first region 402A-C may include a visual item corresponding to the video stream produced by a client device 102A-N. One of the first regions 402A-C can be associated with the conference or meeting room where the meeting devices 110 are located. For example, in FIG. 4, the first region 402A can be associated with the conference or meeting room and can depict a participant speaking from a podium in the conference or meeting room, and the first regions 402B-C can be associated with participants that are not in the conference or meeting room.

The virtual meeting UI 108A may include a meeting devices control UI element 404. The meeting devices control UI element 404 may include one or more meeting device UI elements 406A-F based on the indications of the one or more meeting devices 110 in the conference or meeting room. The meeting device UI elements 406A-F may include a name or identifier of the respective meeting device and/or other information regarding the respective meeting device (e.g., device type, an identifier, etc.). The meeting devices control UI element 404 may include, for each meeting device UI element 406A-F, a status UI element 408A-F based on the status of the respective meeting device. The meeting devices control UI element 404 may include a feature control UI element 410 based on the indication of one or more features of a meeting device. For example, as discussed above, the feature control UI element 410 may include a button that is selectable by a user for each feature of the one or more features of the respective meeting device.

In some implementations, the meeting devices control UI element 404 includes feature control UI elements 410 for the one or more features of all of the meeting devices 110. In other implementations, the meeting devices control UI element 404 includes a feature control UI element 410 for a subset of the meeting devices 110. For example, as seen in FIG. 4, the meeting devices control UI element 404 may include a feature control UI element 410 for only the first meeting device (indicated by the meeting device UI element 406A) in order to not crowd the meeting devices control UI element 404. Responsive to a user interacting with a meeting device UI element 406B-F for a different meeting device, the meeting devices control UI element 404 can present a feature control UI element 410 for the one or more features for the selected meeting device.

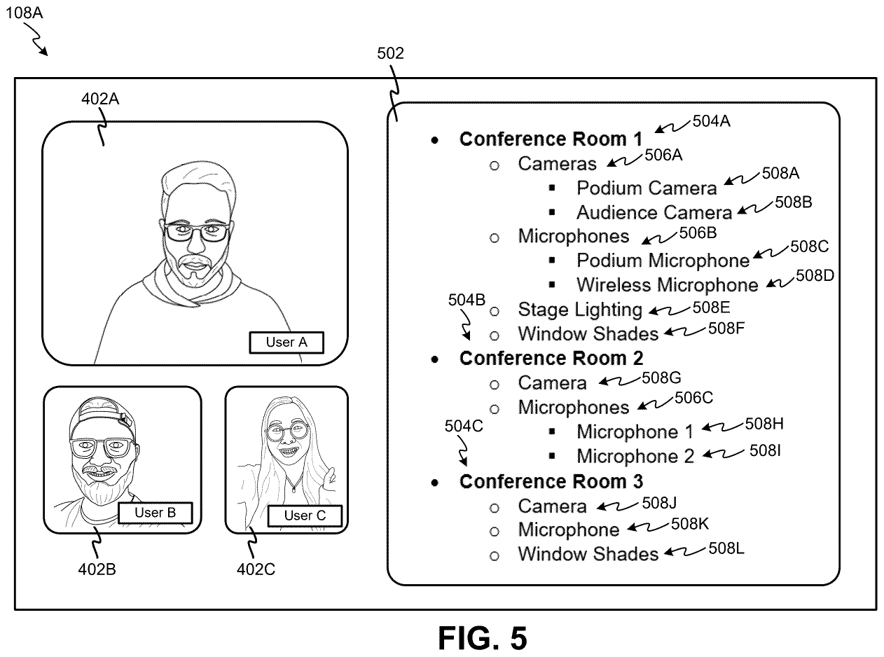

FIG. 5 depicts another example virtual meeting UI 108A, in accordance with some implementations of the present disclosure. The virtual meeting UI 108A may also include the first regions 402A-C. The virtual meeting UI 108A may include a meeting device control UI element 502 that includes UI elements 504A-C, 506A-C, 508A-L corresponding to conference or meeting rooms, types of meeting devices, or specific meeting devices 110 organized in a tree structure. As discussed above, a first level of the tree structure may include UI elements 504A-C based on different conference or meeting rooms. For each UI element 504A-C for a conference or meeting room, the meeting device control UI element 502 may present, at a second level of the tree structure, UI elements 506A-C for one or more types of meeting devices or meeting device UI elements 508E-G, J-L based on meeting devices 110 in the respective conference or meeting rooms. For each type of meeting device, the meeting device control UI element 502 may include, at a third level of the tree structure, meeting device UI elements 508A-D, H-I based on meeting devices 110 belonging to the respective type of meeting device. The meeting device UI elements 508A-L may include UI elements that a user can interact with to cause the meeting device control UI element 502 to display the one or more features of the meeting devices corresponding to the meeting device UI elements 508A-L. The UI elements 504A-C for the conference or meeting rooms and the UI elements 506A-C for the types of meeting devices may include UI elements that a user can interact with the cause the meeting device control UI element 502 to expand or collapse portions of the tree structure.

In some implementations, a user of the first client device 102A may use the virtual meeting UI 108A to cause multiple meeting devices 110 located in a conference room to operate in a predetermined configuration. For example, a conference room may include a first predetermined configuration that includes a first camera 112 being unmuted, a first microphone 114 being unmuted, a first window shade device 118 being in a lowered state, and a first room divider device being in a closed state. The conference room may include a second predetermined configuration that includes the first camera 112 being muted, a second camera 112 being unmuted, the first microphone 114 being unmuted, the first window shade device 118 being in a lowered state, a second window shade device 118 being in a raised state, and the first room divider device being in an open state. The virtual meeting UI 108A may allow the user of the first client device 102A to cause the multiple meeting devices 110 of the conference room to operate in a predetermined configuration selected by the user without the user selecting each individual meeting device and selecting the desired feature of that meeting device.

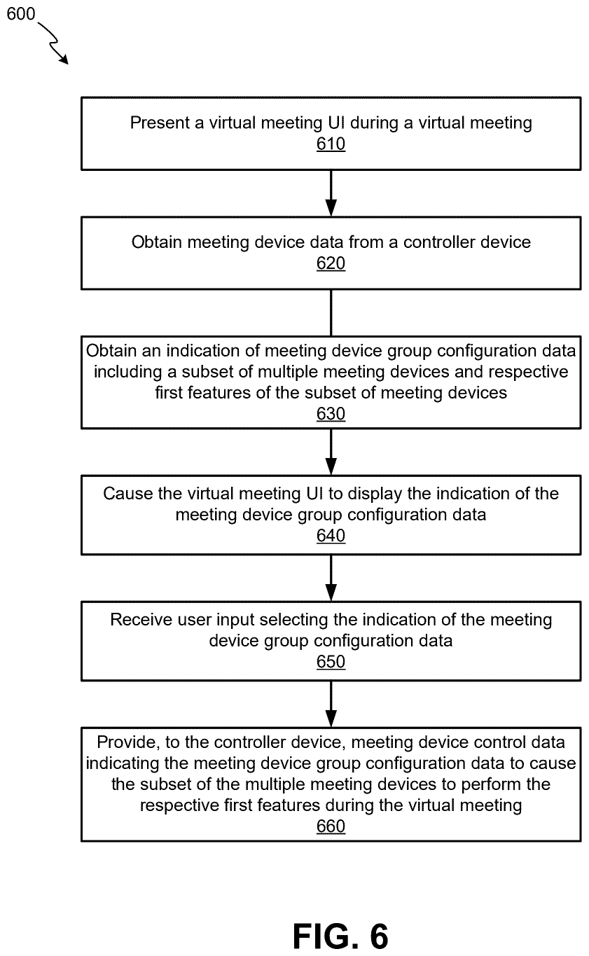

FIG. 6 depicts a flow diagram of a method 600 for controlling conference room virtual meeting devices from a virtual meeting UI, in accordance with some implementations of the present disclosure. The method 600 may include a method for controlling multiple meeting devices according to a predetermined configuration, as discussed above. A processing device, having one or more CPU(s), one or more GPU(s), and/or memory devices communicatively coupled to the one or more CPU(s) and/or GPU(s) can perform the method 600 and/or one or more of the method's 600 individual functions, routines, subroutines, or operations. In certain implementations, a single processing thread can perform the method 600. Alternatively, two or more processing threads can perform the method 600, each thread executing one or more individual functions, routines, subroutines, or operations of the method. In an illustrative example, the processing threads implementing the method 600 can be synchronized (e.g., using semaphores, critical sections, and/or other thread synchronization mechanisms). Alternatively, the processing threads implementing the method 600 can be executed asynchronously with respect to each other. Various operations of the method 600 can be performed in a different (e.g., reversed) order compared with the order shown in FIG. 6. Some operations of the method 600 can be performed concurrently with other operations. Some operations can be optional. In some implementations, the meeting device manager 106 performs one or more of the operations of the method 600.

At block 610, processing logic presents, at a first client device 102A of one or more client devices 102A-N, a virtual meeting UI 108A during a virtual meeting 122 between one or more participants associated with the one or more client devices 102A-N. A subset of the one or more participants are located in a conference room. Block 610 may include functionality similar to the functionality of block 210 of the method 200.

At block 220, processing logic obtains, at the first client device 102A, meeting device data from a controller device 104 in the conference room. The controller device 104 can manage one or more meeting devices 110 in the conference room. The meeting device data may include an indication of the one or more meeting devices 110. The meeting device data may include, for each meeting device 110, one or more features of the respective meeting device 110. Block 620 may include functionality similar to the functionality of block 220 of the method 200.

At block 630, processing logic obtains an indication of meeting device group configuration data. The meeting device group configuration data may include data indicating a subset of the one or more meeting devices 110 (e.g., a group of meeting devices 110). The meeting device group configuration data may include data indicating, for each meeting device 110 in the subset of the one or more meeting devices 110, a first feature of the one or more features of the respective meeting device 110. The meeting device group configuration data may indicate a predetermined configuration for the subset of meeting devices 110 in the conference room.

In one implementation, obtaining the meeting device group configuration data includes obtaining the meeting device group configuration data from the controller device 104. The controller device 104 may include one or more meeting device group configurations, and the controller device 104 may provide data indicating those meeting device group configurations to the meeting device manager 106. In some implementations, obtaining the meeting device group configuration data includes obtaining the meeting device group configuration data from a virtual meeting application 105 of the first client device 102A. For example, the meeting device manager 106 may store data indicating one or more meeting device group configurations.

At block 640, processing logic causes the virtual meeting UI 108A to display the indication of the meeting device group configuration data (e.g., by updating the virtual meeting UI 108A to display the indication of the meeting device group configuration data or by sending the meeting device group configuration data to the server 130 which can then update the virtual meeting UI 108A to display the indication of the meeting device group configuration data and provide it for presentation on the first client device 102A). The meeting device manager 106 can cause the virtual meeting UI 108A to display the indication. In some implementations, the virtual meeting UI 108A displaying the indication of the meeting device group configuration data is presented to each participant of the virtual meeting 122. Alternatively, the virtual meeting UI 108A displaying the indication of the meeting device group configuration data is presented to participants located in the conference room and not to the remote participants of the virtual meeting 122. Yet alternatively, the virtual meeting UI 108A displaying the indication of the meeting device group configuration data is presented to a user (e.g., a system administrator) having particular privileges (e.g., upon such a user entering their credentials) but not to any participants of the virtual meeting 122 who do not have the required privileges.

In one implementation, the virtual meeting UI 108A displaying the indication of the meeting device group configuration data includes the virtual meeting UI 108A displaying a UI element that corresponds to the meeting device group configuration data. The UI element may include a box or other enclosed UI element. The UI element can display data indicating the subset of the meeting devices 110, which may include the names of the meeting devices 110 in the subset, a type of each meeting device in the subset, or other data. The UI element can display data indicating, for each device in the subset of meeting devices 110, a feature of the respective meeting device 110. The feature of the respective meeting device 110 may include the feature the respective meeting device 110 performs responsive to the meeting device group configuration being selected by the user of the first client device 102A. The UI elements may include UI elements that a user of the first client device 102A can interact with (e.g., buttons, sliders, or the like).

In some implementations, the meeting device data further includes a respective status of each meeting device of the one or more meeting devices 110. The respective status of a meeting device 110 may include “normal,” “offline,” or a status indicating that the meeting device 110 has experienced an error. In one implementation, causing the virtual meeting UI 108A to display the meeting device group configuration data includes causing the virtual meeting UI 108A to display the respective status of each meeting device of the subset of the one or more meeting devices 110. In some implementations, causing the virtual meeting UI 108A to display the meeting device group configuration data includes causing the virtual meeting UI 108A to display a status for the meeting device group configuration.

In some implementations, the virtual meeting UI 108A displays multiple UI elements, and each UI element corresponds to a different meeting device group configuration. Different meeting device group configurations can be indicated by different UI elements. The user of the first client device 102A can select a UI element of the multiple UI elements to select the corresponding meeting device group configuration, as discussed below.

At block 650, processing logic receives, via the virtual meeting UI 108A, user input selecting the indication of the meeting device group configuration data. For example, as discussed above, the virtual meeting UI 108A may include a UI element that indicates first meeting device group configuration data. A user of the first client device 102A can interact with the UI element to select the first meeting device group configuration. The meeting device manager 106 can obtain data from the virtual meeting UI 108A indicating the first meeting device group configuration.

At block 660, processing logic provides, to the controller device 104, meeting device control data indicating the meeting device group configuration data to cause the subset of the one or more meeting devices 110 to perform the respective first features during the virtual meeting 122. In one implementation, the meeting device manager 106 generates the meeting device control data based on the data from the virtual meeting UI 108A indicating the selected meeting device group configuration. The meeting device manager 106 can provide the meeting device control data to the controller device 104. The controller device 104 can provide commands to the meeting devices in the subset of the one or more meeting devices 110, and the commands, when received by a respective meeting device, can cause the meeting device to perform the feature indicated by the meeting device group configuration for that meeting device.

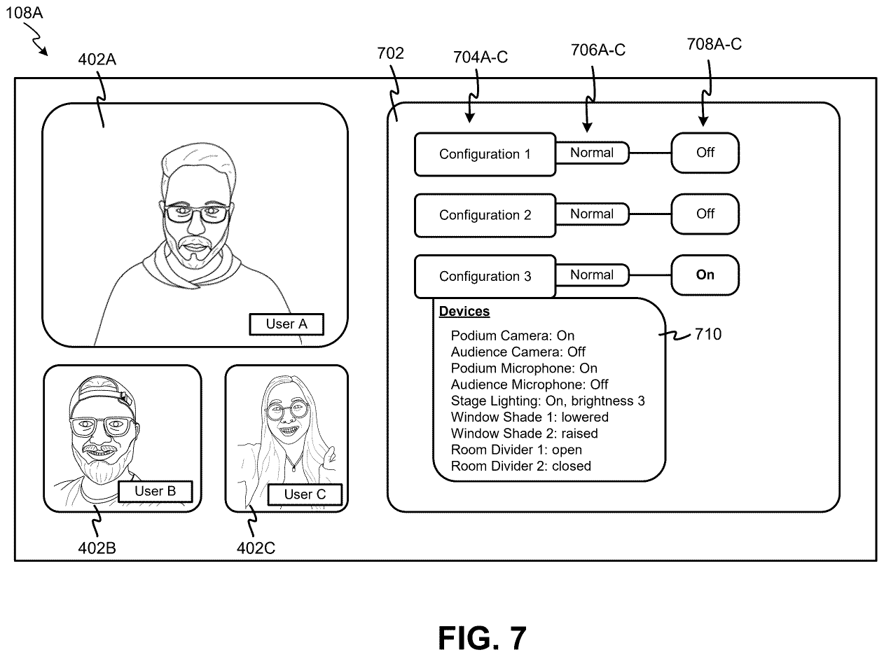

FIG. 7 depicts an example virtual meeting UI 108A, in accordance with some implementations of the present disclosure. Similar to the virtual meeting UI 108A of FIG. 4, the virtual meeting UI 108A may include one or more first regions 402A-C that include a visual item corresponding to the video stream produced by a client device 102A-N. The virtual meeting UI 108A may include a meeting device group configuration control UI element 702. The meeting device group configuration control UI element 702 may include one or more meeting device group configuration UI elements 704A-C based on the indications of meeting device group configuration data. A meeting device group configuration UI element 704A-C may include a name or identifier of a corresponding meeting device group configuration. The meeting device group configuration control UI element may include, for each meeting device group configuration 704A-C, a status UI element 706A-F based on the status of the corresponding meeting device group configuration.

The meeting device group configuration control UI element 702 may include one or more meeting device group configuration selection UI elements 708A-C. A meeting device group configuration selection UI element 708A-C may include a UI element (e.g., a button) that the user of the first client device 102A can interact with to select the associated meeting device group configuration, as discussed above in relation to block 650 of the method 600. In some implementations, the one or more meeting device group configuration selection UI elements 708A-C may operate as radio buttons so that a single meeting device group configuration selection UI element 708A-C can be selected at a time. The one or more meeting device group configuration selection UI elements 708A-C may present a visual indication (e.g., text, an icon, etc.) that indicates which meeting device group configuration (if any) is currently selected.

In some implementations, the meeting device group configuration control UI element 702 includes a meeting devices UI element 710. The meeting devices UI element 710 may be associated with a meeting device group configuration UI element 704A-C. The meeting devices UI element 710 may indicate the subset of the one or more meeting devices 110 of the corresponding meeting device group configuration and, for each meeting device in the subset, the feature of the respective meeting device. For example, as seen in FIG. 7, the meeting devices UI element 710 indicates that, responsive to the user of the first client device 102A selecting the third meeting device group configuration UI element 704C, the controller device 104 will cause a first camera 112 named “Podium Camera” to unmute and a second camera 112 named “Audience Camera” to mute. The example meeting devices UI element 710 indicates that, responsive to the user of the first client device 102A selecting the third meeting device group configuration UI element 704C, the controller device 104 will cause a first microphone 114 named “Podium Microphone” to unmute and a second microphone 114 named “Audience Microphone” to mute. The meeting devices UI element 710 indicates that, responsive to the user of the first client device 102A selecting the third meeting device group configuration UI element 704C, the controller device 104 will cause a lighting device 116 named “Stage Lighting” to activate and use a brightness setting of “3.” The meeting devices UI element 710 indicates that, responsive to the user of the first client device 102A selecting the third meeting device group configuration UI element 704C, the controller device 104 will cause a first window shade 116 device named “Window Shade 1” to be lowered and a second window shade device 116 named “Window Shade 2” to be raised. The meeting devices UI element 710 indicates that, responsive to the user of the first client device 102A selecting the third meeting device group configuration UI element 704C, the controller device 104 will cause a first room divider device named “Room Divider 1” to open and a second room divider device to close.

In one implementation, at a first time, the user of the client device 102A may use the meeting device group configuration control UI element 702 to select a meeting device group configuration and cause the controller device 104 to cause the subset of the one or more meeting devices 110 to perform the respective features during the virtual meeting as indicated by the meeting device group configuration. At a second time after the first time, the user of the client device 102A may use the meeting devices control UI element 404 of the virtual meeting UI 108A of FIG. 4 to select an individual meeting device and cause the meeting device to perform a feature selected by the user using the meeting devices control UI element 404. In this manner, the user may initially select a meeting device group configuration and cause the subset of meeting devices to perform the respective features indicated by the meeting device group configuration, and the user may subsequently select a different feature for a meeting device in the subset.

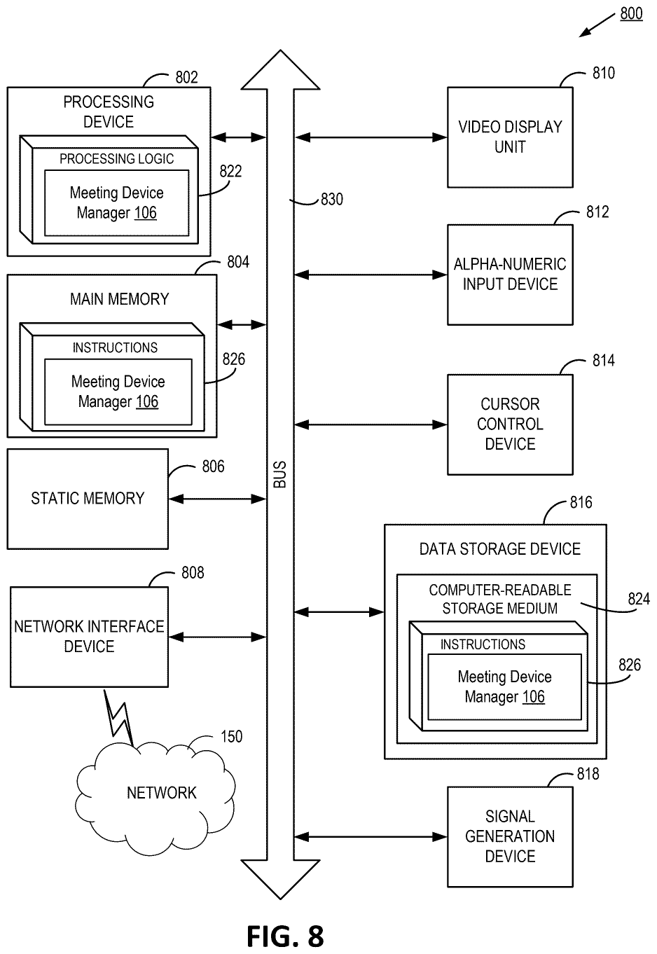

FIG. 8 is a block diagram illustrating an example computer system, in accordance with implementations of the present disclosure. The computer system 800 can include a client device 102A-N, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., the operations of the meeting device manager 106).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the meeting device manager 106) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 150 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
presenting, at a first client device of a plurality of client devices, a virtual meeting user interface (UI) during a virtual meeting between a plurality of participants associated with the plurality of client devices, wherein a subset of the plurality of participants are located in a conference room;
obtaining, at the first client device, meeting device data from a controller device in the conference room, wherein the controller device manages a plurality of meeting devices in the conference room, and wherein the meeting device data comprises an indication of:
a first meeting device of the plurality of meeting devices, and
one or more features of the first meeting device;
causing the virtual meeting UI to display the indication of the first meeting device and the one or more features of the first meeting device;
receiving, via the virtual meeting UI, user input selecting a first feature of the one or more features of the first meeting device; and
providing, to the controller device, meeting device control data indicating the first meeting device and the first feature to cause the first meeting device to perform the first feature during the virtual meeting.

2. The method of claim 1, wherein the first meeting device comprises a camera.

3. The method of claim 2, wherein the indication of the one or more features of the first meeting device comprises at least one of:
unmuting the camera;
muting the camera; or
or a pan/tilt/zoom (PTZ) operation.

4. The method of claim 1, wherein the first meeting device comprises a microphone.

5. The method of claim 4, wherein the indication of the one or more features comprises at least one of:
unmuting the microphone; or
muting the microphone.

6. The method of claim 1, wherein the first meeting device comprises a lighting device.

7. The method of claim 6, wherein the indication of the one or more features comprises at least one of:
activating the lighting device;
deactivating the lighting device;
increasing a brightness of the lighting device;
decreasing the brightness of the lighting device;
modifying a color of the lighting device; or
modifying a color temperature of the lighting device.

8. The method of claim 1, wherein the first meeting device comprises a window shade device.

9. The method of claim 8, wherein the indication of the one or more features comprises at least one of:
retracing a window shade; or
extending the window shade.

10. A system, comprising:
a memory; and
a processing device, coupled with the memory, configured to perform operations comprising:
presenting, at a first client device of a plurality of client devices, a virtual meeting user interface (UI) during a virtual meeting between a plurality of participants associated with the plurality of client devices, wherein a subset of the plurality of participants are located in a conference room,
obtaining, at the first client device, meeting device data from a controller device in the conference room, wherein the controller device manages a plurality of meeting devices in the conference room, and wherein the meeting device data comprises an indication of:
a first meeting device of the plurality of meeting devices, and
one or more features of the first meeting device,
causing the virtual meeting UI to display the indication of the first meeting device and the one or more features of the first meeting device,
receiving, via the virtual meeting UI, user input selecting a first feature of the one or more features of the first meeting device, and
providing, to the controller device, meeting device control data indicating the first meeting device and the first feature to cause the first meeting device to perform the first feature during the virtual meeting.

11. The system of claim 10, wherein:
the meeting device data further comprises a status of the first meeting device; and
the status of the first meeting device comprises at least one of normal, offline, or has an error.

12. The system of claim 11, wherein the virtual meeting UI displays the status of the first meeting device.

13. The system of claim 10, wherein:
the first meeting device comprises a system of a plurality of cameras; and
the indication of the one or more features of the first meeting device comprises changing an active camera from a first camera of the plurality of cameras to a second camera of the plurality of cameras.

14. The system of claim 10, wherein:
the first meeting device comprises a system of a plurality of microphones; and
the indication of the one or more features of the first meeting device comprises changing an active microphone from a first microphone of the plurality of microphones to a second microphone of the plurality of microphones.

15. The system of claim 10, wherein:
the meeting device data comprises an indication of a plurality of meeting devices, wherein the plurality of meeting devices includes the first meeting device; and
the virtual meeting UI displaying the indication of the first meeting device comprises the virtual meeting UI displaying a tree structure organizing the plurality of meeting devices into one or more groups of meeting devices.

16. The system of claim 15, wherein the one or more groups of meeting devices is based on one or more locations of the plurality of meeting devices.

17. A non-transitory computer-readable storage medium with instructions that, when executed by a processing device, cause the processing device to perform operations comprising:
presenting, at a first client device of a plurality of client devices, a virtual meeting user interface (UI) during a virtual meeting between a plurality of participants associated with the plurality of client devices, wherein a subset of the plurality of participants are located in a conference room;
obtaining, at the first client device, meeting device data from a controller device in the conference room, wherein the controller device manages a plurality of meeting devices in the conference room, and wherein the meeting device data comprises an indication of:
the plurality of meeting devices, and
for each meeting device of the plurality of meeting devices, one or more features of the respective meeting device;
obtaining an indication of meeting device group configuration data, comprising:
a subset of the plurality of meeting devices, and
for each meeting device in the subset of the plurality of meeting devices, a first feature of the one or more features of the respective meeting device;
causing the virtual meeting UI to display the indication of the meeting device group configuration data;
receiving, via the virtual meeting UI, user input selecting the indication of the meeting device group configuration data; and
providing, to the controller device, meeting device control data indicating the meeting device group configuration data to cause the subset of the plurality of meeting devices to perform the respective first features during the virtual meeting.

18. The computer-readable storage medium of claim 17, wherein obtaining the meeting device group configuration data comprises at least one of:
obtaining the meeting device group configuration data from the controller device; or
obtaining the meeting device group configuration data from a virtual meeting application of the first client device.

19. The computer-readable storage medium of claim 17, wherein:
the subset of the plurality of meeting devices comprises a first camera and a second camera;
the first feature of the first camera includes unmuting the first camera; and
the first feature of the second camera includes muting the second camera.

20. The computer-readable storage medium of claim 17, wherein:
the meeting device data further comprises a respective status of each meeting device of the plurality of meeting devices;
the respective status of a meeting device of the plurality of meeting devices comprises at least one of normal, offline, or has an error; and
causing the virtual meeting UI to display the meeting device group configuration data comprises causing the virtual meeting UI to display the respective status of each meeting device of the subset of the plurality of meeting devices.
